(19) United States
(12) Patent Application Publication
(10) Pub. No.: US 2006/0169499 A1
(43) Pub. Date: Aug. 3, 2006

(54) Tiller-guided industrial truck

(75) Inventor: Bernhard Gotz, Aschaffenburg (DE)

Correspondence Address: THE WEBB LAW FIRM, P.C., 700 KOPPERS BUILDING, 436 SEVENTH AVENUE, PITTSBURGH, PA, 15219, US

(73) Assignee: Linde Aktiengesellschaft, Wiesbaden (DE)

(21) Appl. No.: 11/039,361

(22) Filed: Jan. 20, 2005

(51) Int. Cl. B62D 51/04

(52) U.S. Cl. 180/19.1

(57) ABSTRACT

The invention relates to a tiller-guided industrial truck. At least one device (12) is provided to adjust the vertical position of a horizontal pivot pin (7) of the tiller (4).

### CROSS-REFERENCE TO RELATED APPLICATION

This application claims priority to German Application No. 102004003331.5 filed Jan. 22, 2004, which is herein incorporated by reference in its entirety.

### BACKGROUND OF THE INVENTION

1. Field of the Invention

The invention relates to a tiller-guided industrial truck.

2. Technical Considerations

Drawbar-guided industrial trucks are used for the in-house transportation of goods, in particular where there are restricted space conditions and short transportation distances. These vehicles are generally designed such that an operator walks along in front of or next to the industrial truck and steers it by means of a tiller. For this purpose, the operator grasps a tiller head, which generally has two handles which are perpendicular to the tiller shaft and are each provided with a hoop guard. In the case of electrically driven vehicles, the steering is also generally actuated by a direct connection between the drive wheel and steering tiller. In the case of a loaded vehicle, this requires a considerable exertion of force. It is, therefore, desirable to provide a tiller which, as long as possible, produces a large lever arm for actuating the steering. When maneuvering in a narrow space, an operator pivots the tiller upwardly as far as possible so as to require less space. When a long tiller is set at the same angle by relatively shorter operators compared to taller people, the tiller head stands too high and the shorter operator can only apply the required force to turn the tiller with difficulty. In addition, because of the non-ergonomic position, the operator tires more quickly. If the horizontal pivot pin of the tiller is attached so low that shorter operators can also easily operate it in the elevated position, operation is made more difficult during normal travel operation for taller operators. A length-adjustable tiller, as known from DE 27 51 333, allows automatic length reduction when elevating the tiller, which facilitates maneuvering when the tiller is elevated for smaller operators. A tiller construction of this type is very expensive, however. Handling, in particular sensitive maneuvering, is made more difficult for an operator who is used to tillers with a fixed length owing to the length which depends on the angle of elevation.

Therefore, it is an object of the invention to provide a tiller-guided industrial truck which is equally suitable for operators of different heights and can be operated sensitively and can be produced at a low outlay.

### SUMMARY OF THE INVENTION

This object is achieved according to the invention in that at least one device is provided to adjust the vertical position of a horizontal pivot pin of the tiller. Since the pivot pin can be vertically adjusted, the height of the tiller can be adapted to the height of the operator without an unfavorable setting angle and, therefore, unfavorable lever conditions being produced. The tiller can be operated sensitively and precisely. A vertical adjustment is robust, easy to produce and easy to operate.

It is particularly advantageous if the adjustment path for the vertical position of the horizontal pivot pin of the tiller is between 50 mm and 200 mm, such as between 80 mm and 140 mm. A device with this adjustment range requires comparatively little installation space and is, therefore, advantageous in the case of restricted space conditions, such as typically exist in the case of tiller vehicles. At the same time, good adaptation is possible in the case of operators of very different heights.

The device can expediently be manually actuated to adjust the vertical position of the horizontal pivot pin of the tiller by an operator with simple means, preferably without a tool. Therefore, when there is a change of operator, for example, the new operator can adjust the tiller to the height suited to him without great effort.

In an advantageous embodiment of the invention, the device for adjusting the vertical position of the horizontal pivot pin of the tiller is provided with at least one drive device, such as an electric and/or hydraulic drive. The horizontal pivot axis of the tiller can be adjusted thereby without a great exertion of force to the desired height. An automatic adaptation, for example, depending on the operator, allowing adjustment in a force and time-saving manner is also thus allowed.

In an advantageous embodiment of the invention, the position of the pivot pin of the tiller can be non-positively locked, for example, by means of at least one screw-actuated clamping device. Non-positive connections are easy to produce and allow rapid and continuous adjustment of the height. Overloading of the connection does not lead to a breakage of the components, but to slipping or release of the connection.

In a further advantageous embodiment of the invention, the position of the pivot pin of the tiller can be locked in an interlocking manner, such as by means of at least. one resiliently mounted plug-in element. Interlocking connections are particularly secure with respect to unintended adjustment and reliably transmit large forces. As the strength of the lock in contrast to non-positive connections is not dependent on a locking force which has to be applied by an operator, even relatively weak operators can carry out the adjustment without great effort. Resiliently mounted elements are particularly suitable as these automatically latch into the locking position.

It is particularly advantageous if the device for height adjustment of the pivot pin of the tiller is designed as a toothed rack device. In devices of this type, a toothed wheel is moved past a toothed rack by a rotary movement. This allows a simple continuous height adjustment, for example, by means of a crank mechanism which drives the toothed wheel.

It is also advantageous if at least one spring element is provided which assists the movement of the horizontal pivot pin of the tiller in at least one direction. Smaller operating forces are therefore required in order to move the pivot pin, which generally carries the full weight of the tiller.

In an advantageous embodiment of the invention, the length of the tiller can be changed. This allows still better adaptation of the tiller to the height of the operator. When maneuvering in narrow spaces, the maneuverability of the industrial truck can also be improved.

It is also advantageous if the device for the height adjustment of the horizontal pivot pin of the tiller is arranged inside at least one drive housing of the industrial truck. The device is, therefore, protected from soiling and damage, the risk of danger to operators is reduced, and production is simplified.

### BRIEF DESCRIPTION OF THE DRAWINGS

Further advantages and details of the invention are described in more detail with the aid of an embodiment shown in the schematic figures, in which like reference numbers identify like parts throughout.

FIG. 1 shows a lateral view of a fork lift truck as an example of an industrial truck according to the known art; and

FIG. 2 shows a lateral view of a device according to the invention for the height adjustment of the horizontal pivot pin of the tiller, which is integrated into a drive housing.

### DESCRIPTION OF THE PREFERRED EMBODIMENTS

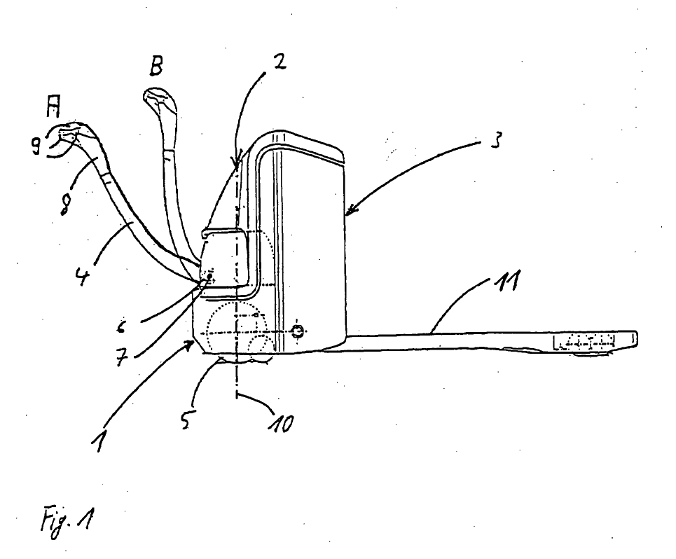

FIG. 1 shows, as an example of a conventional industrial truck according to the known art, a fork lift truck 1 with a drive part 2, a load part 3, and a tiller 4. Accommodated in the drive part 2 are inter alia a travel drive and a lift drive and their electronic control components, not shown here. The travel drive drives a drive wheel 5 which is steered by the tiller 4. The tiller 4 is movably mounted about a horizontal pin 7 on an articulated part 6. A tiller head 8 is attached on the operator end of the tiller 4. The operating elements 9 to control the functions of the industrial truck 1 are arranged on the tiller head 8. In order to steer the industrial truck 1, the operator grasps the tiller head 8 and can pre-select the travel direction by turning the tiller 4 about the vertical axis 10. A load is received and lifted on the load receiving means 11. A hydraulic system, not shown here, in which a lifting cylinder is supplied with hydraulic fluid by a hydraulic pump driven by an electric motor is generally used as the lift drive. During normal operation of the industrial truck, the tiller head 8 is held approximately in the position “A” by an operator of normal height. Owing to the long lever arm, it is easy to carry out pivoting about the vertical axis 10. For maneuvering in a narrow space, the tiller 4 is moved by the operator from the position “A” into the position “B”. Less space is therefore necessary, but larger forces are required for steering.

When the tiller 4 is elevated (position “B”) the tiller head 8 is substantially harder to operate for an operator who is significantly smaller than the average operator. In particular, it is difficult to apply the forces required for steering. For an operator who is substantially taller than the average operator, the position “A” is relatively low and, therefore, difficult to reach.

Therefore, a tall operator will set the tiller 4 substantially higher during normal operation than an operator of normal size and must, therefore, apply correspondingly large forces during steering.

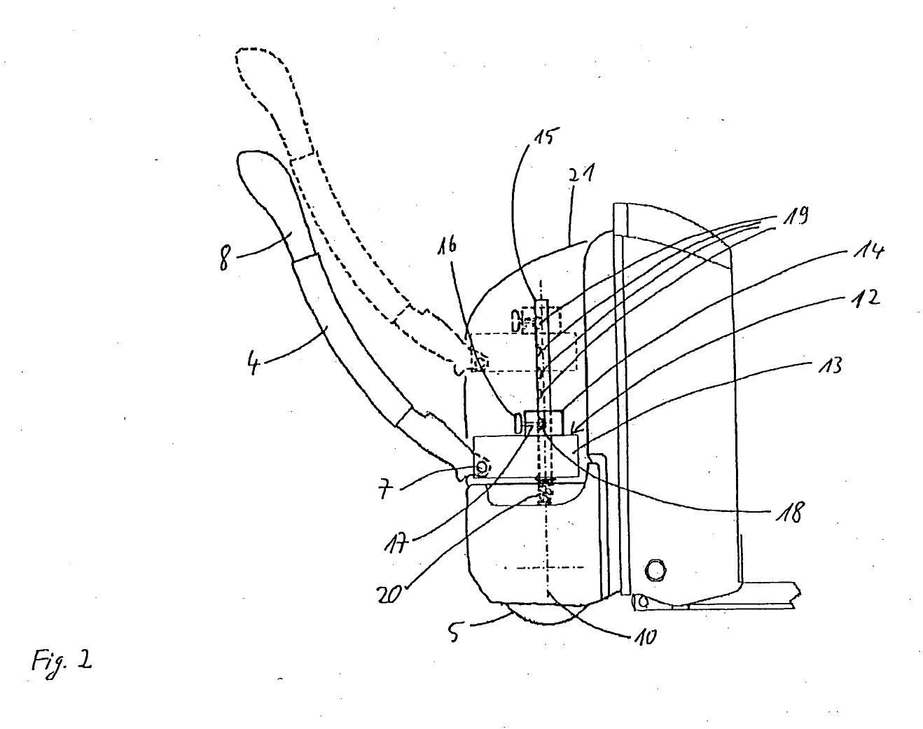

FIG. 2 shows a lateral view of a device according to the invention for the height adjustment of the horizontal pivot pin 7 of the tiller 4. The same components are designated the same as in FIG. 1. The solid line shows the tiller 4 in the lowest position of the horizontal pivot pin 7. In this position, a small operator can operate the tiller 4 well when it is virtually perpendicular during maneuvering (e.g., position “B” in FIG. 1) and can easily steer the industrial truck 1. The highest position of the horizontal pivot pin is shown by dashed lines in FIG. 2. In this position, the tiller 4 can be easily reached by tall operators in normal accompanying operation (e.g., position “A” in FIG. 1). The device 12 for adjusting the vertical position of the horizontal pivot pin 7 of the tiller 4 comprises, in the embodiment shown, a guide device 13, which also carries the horizontal pivot pin 7, as well as a locking device 14, by means of which the vertical position of the device 12 can be fixed. The guide device 13 is guided on a guide rail 15 substantially parallel to the vertical pivot axis 10 and secured against twisting by conventional means, for example by a non-rotationally symmetrical cross section of the guide rail 15 or by grooves and guide elements running therein or holes for securing pins. The guide rail 15 is in operative connection with the steerable drive wheel 5 of the vehicle 1. To adjust the vertical position of the device 12, an actuating element 16 is disengaged by drawing a resiliently mounted plug-in element, e.g., pin 17, from a hole 18 provided in the guide rail 15. The device 12 can therefore be raised or lowered and be fixed at the desired height again by inserting the fixing pin 17 in another hole 19. If the fixing pin 17 has virtually the same dimensions as the holes 18, 19, steering forces can also be transmitted with the fixing pin 17, so a particularly simple construction is achieved.

So that the operator does not have to lift the total weight of the device 12 and the tiller 4 during height adjustment, a spring element 20 is arranged on the guide rail 15. The spring element 20 presses the device 12 and the tiller 4 upwardly, the spring force being selected depending on the requirements such that either the total weight of the tiller 4 and device 12 are compensated and, therefore, the tiller 4 is always pressed towards the upper adjustment point without locking, or else only part of the weight, so only lifting is facilitated. The device 12 for adjusting the vertical position of the horizontal pivot pin 7 of the tiller 4 is arranged inside the drive housing 21 and is thus protected from soiling, damage, and unintentional adjustment.

Further embodiments are conceivable. For example, instead of the fixing pin 17, a clamping screw may also be provided for locking the device 12 at a desired height. The clamping screw can be guided in the locking device 14 in a thread and presses, in the tightened state, either directly or via a suitable device for distributing the force onto the guide rail 15 and thus produces a non-positive connection between the guide rail 15 and device 12. To adjust the vertical position of the device 12, the clamping screw is released; the device 12 is lifted or lowered and again fixed with the clamping screw. A height adjustment of the horizontal pivot pin 7 via a toothed rack device continues to be possible. In the process, a toothed wheel connected to the device 12 engages in a toothed rack provided on the guide rail 15. By turning the toothed wheel, the vertical position of the device 12 is changed. The toothed wheel can be turned both manually, for example by means of a hand crank or a hand wheel, and also automatically, for example by means of an electric motor. In the case of hydraulic height adjustment or height adjustment by means of an electric motor, it is no longer necessary to open the drive housing 21 in order to adjust the height of the horizontal pivot pin 7. In particular, this may be carried out by operating elements 9 on the tiller head 8 or else automatically, for example depending on the user.

The device 12 may also be guided on the inside of the cylindrical drive housing 21 which receives the drive unit of the industrial truck 1, a simple construction thus being achieved.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

What is claimed is:

1. A tiller-guided industrial truck, comprising:
a tiller movable round a horizontal pivot pin; and
at least one device configured to adjust a vertical position of the horizontal pivot pin of the tiller.

2. The tiller-guided industrial truck according to claim 1, wherein an adjustment path for the vertical position of the horizontal pivot pin of the tiller is between 50 mm and 200 mm.

3. The tiller-guided industrial truck according to claim 2, wherein the adjustment path for the vertical position of the horizontal pivot pin of the tiller is between 80 mm and 140 mm.

4. The tiller-guided industrial truck according to claim 1, wherein the device for adjusting the vertical position of the horizontal pivot pin of the tiller can be manually actuated by an operator without a tool.

5. The tiller-guided industrial truck according to claim 1, wherein the device for adjusting the vertical position of the horizontal pivot pin of the tiller includes at least one drive device.

6. The tiller-guided industrial truck according to claim 1, wherein the vertical position of the horizontal pivot pin of the tiller can be non-positively locked.

7. The tiller-guided industrial truck according to claim 1, wherein the vertical position of the horizontal pivot pin of the tiller can be locked in an interlocking manner.

8. The tiller-guided industrial truck according to claim 1, wherein the device for height adjustment of the horizontal pivot pin of the tiller includes a toothed rack device.

9. The tiller-guided industrial truck according to claim 1, further comprising at least one spring element configured to assist movement of the horizontal pivot pin in at least one direction.

10. The tiller-guided industrial truck according to claim 1, wherein the length of the tiller is adjustable.

11. The tiller-guided industrial truck according to claim 1, wherein the device for height adjustment of the horizontal pivot pin of the tiller is arranged inside at least one drive housing of the industrial truck.

12. The tiller-guided industrial truck according to claim 5, wherein the drive device comprises an electric drive device and/or a hydraulic drive device.

13. The tiller-guided industrial truck according to claim 6, wherein the vertical position is locked by at least one screw-actuated clamping device.

14. The tiller-guided industrial truck according to claim 7, wherein the vertical position is locked by at least one resiliently mounted plug-in element.
